(19) United States
(12) Patent Application Publication
(10) Pub. No.: US 2009/0147213 A1
(43) Pub. Date: Jun. 11, 2009

(54) Creative Eyeglass Frames

(76) Inventor: Paula D. Poole, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/330,326

(22) Filed: Dec. 8, 2008

Related U.S. Application Data
(60) Provisional application No. 61/005,752, filed on Dec. 6, 2007.

(51) Int. Cl. G02C 11/02

(52) U.S. Cl. 351/52

(57) ABSTRACT

Eyeglass frames are provided that are made to have items or jewelry put on to various bars that are attached to the frames. These frames allow an individual to give the eyeglasses a different look every time that individual wears his or her eyeglasses. The bars on the frames may be integral with the frames or may be attached to the frames with a device such as a hinge. Decorative items may be threaded over the bars.

This Application claims priority to U.S. Provisional Application No. 61/005,752, with a filing date of Dec. 6, 2007.

### FIELD

The present invention relates generally to eyeglass frames. More particularly, the present invention relates to attachable pieces for use with eyeglass frames.

### BACKGROUND

Soon after the first eyeglasses, frames to support the eyeglasses on the face of a user developed. Eyeglasses and frames for the eyeglasses have existed for at least several hundred years. The purpose of these frames has been to support the eyeglasses on a user's face. It has become increasingly popular for a user to express himself fashionably with his eyewear. Thus eyeglass frames come in a variety of styles, materials, and colors.

However, a user may wish to further individualize his eyewear. The current frames do not allow for much creative expression beyond color and material. Children who must wear glasses usually stand out among their peers. Glasses are typically seen amongst children as undesirable, as they are viewed as boring or perhaps even ugly. A child who has no choice but to embark upon wearing glasses may be upset by this new obligation, and dread wearing the boring, ugly glasses as he is trying to fit in with his peers. If the eyewear could be made to be fashionable and fun, a child might instead be excited to wear his glasses.

Adults may also wish to individualize their eyewear, and may become frustrated with the lack of options as they must select a frame that is available for purchase. Current frames on the market do not allow for a user to implement his own design changes to the frames.

### SUMMARY

An eyeglass frame and frame components for a user are provided. These frames and components allow the user to implement his own design changes by adding decorative items to the frame. The eyeglass frame comprises a first end piece and a second end piece. Each of the first end piece and the second end piece comprises a first end and a second end. The eyeglass frame also comprises a frame front, wherein the frame front comprises a bridge, a first rim, and a second rim. Each of the rims contains a lens. A first hinge attaches the first end of the first end piece to the first rim of the frame front. A second hinge attaches the first end of the second end piece to the second rim of the frame front. A bar is removably attachable to the frame front, and may be secured to the frame front with a closure device.

In another embodiment, an eyeglass frame for a user is provided that comprises a first end piece and a second end piece. Each of the first end piece and the second end piece comprises a first end and a second end. The eyeglass frame also comprises a frame front, wherein the frame front comprises a bridge, a first rim, and a second rim. Each of the rims contains a lens. A first hinge attaches the first end of the first end piece to the first rim of the frame front. A second hinge attaches the first end of the second end piece to the second rim of the frame front. At least one bar comprises a first end and a second end. The first end is affixed to either the first rim or the second rim, and the second end is a free end. The free end further comprises a removable stopper.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1a illustrates a perspective view of an exemplary eyeglass frame according to the present invention;

FIG. 1b illustrates a perspective view of the exemplary eyeglass frame of FIG. 1a, with a bar that extends beyond the length of the frame front;

FIG. 2 illustrates a side view of an end piece of the eyeglass frame of FIG. 1a;

FIG. 3a illustrates an exemplary eyeglass frame with arced bars according to one embodiment of the present invention;

FIG. 3b illustrates an exemplary eyeglass frame with bent bars according to one embodiment of the present invention;

FIG. 3c illustrates an exemplary eyeglass frame with vertical straight bars according to one embodiment of the present invention;

FIG. 3d illustrates an exemplary eyeglass frame with straight bars that are parallel to the end piece according to one embodiment of the present invention;

FIG. 3e illustrates an alternative embodiment for the horizontal straight bars shown in FIG. 3d;

FIG. 4a illustrates an exemplary eyeglass frame with rotatable bars, according to the present invention;

FIG. 4b illustrates an exemplary eyeglass frame with rotatable bars, according to the present invention;

FIG. 5a illustrates an exemplary end piece that may be used with an eyeglass frame; and

FIG. 5b illustrates the end piece of FIG. 5a in the unlocked position.

### DETAILED DESCRIPTION

In accordance with the present invention, eyeglass frames are provided. The eyeglass frames may be worn by men, women, and children of all ages. The eyeglass frames are made to have items or jewelry put on various attachments to the frames or the frames themselves to give the frames a different look every time a user wears his eyeglasses. The eyeglasses used with the following invention may be made of a variety of materials, for example but not limited to wood, metal, bone, horn, or plastic. The eyeglasses may be used for either correctional or non-correctional lenses.

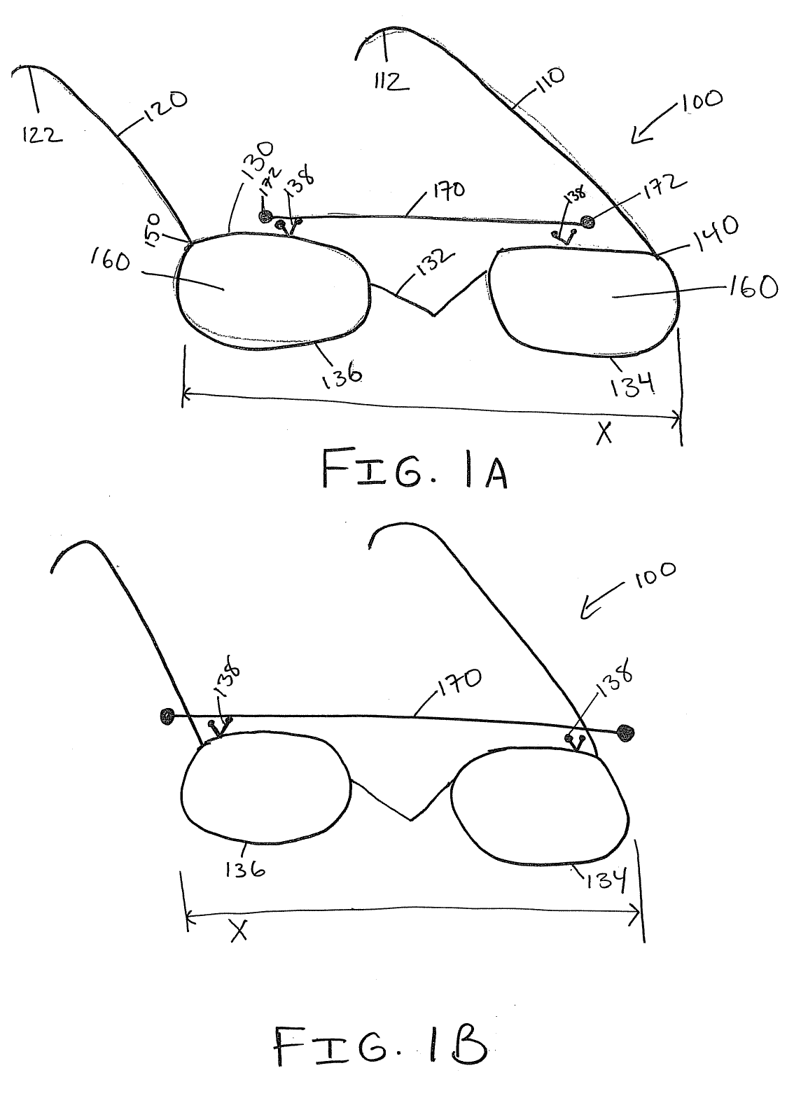

FIG. 1a shows a perspective view of an exemplary eyeglass frame 100 according to the present invention. Eyeglass frame 100 comprises a first end piece 110, a second end piece 120, a frame front 130, a first hinge 140, a second hinge 150, and a plurality of lenses 160. Frame front 130 further comprises a bridge 132, a first rim 134, and a second rim 136. Frame front 130 comprises a length X. First end piece 110 comprises a first temple 112. Second end piece 120 comprises a second temple 122.

First end piece 110 is connected to first rim 134 of frame front 130 with first hinge 140. Second end piece 120 is connected to second rim 136 of frame front 130 with second hinge 150.

A bar 170 may be removably attached to frame front 130. Frame front 130 may comprise a plurality of closure devices 138. Closure devices 138 may be manually opened to receive bar 170. Once bar 170 is placed in each clip of closure device 138, each device may be manually closed, effectively affixing bar 170 to frame front 130. More specifically, bar 170 may be attached to first rim 134 and second rim 136 of frame front 130. Bar 170 may comprise a length that extends to a plurality of ends 172, wherein the plurality of ends 172 may be located at any point within length X. Alternatively, the length of bar 170 may be such that the first plurality of ends 172 may comprise a length that extends beyond length X, that is, beyond the rims of frame front 130, as shown in FIG. 1b. In this case, closure devices 138 may be spaced further apart on frame front 130 so as to better support the longer bar 170.

Alternatively, closure devices 138 may be on the first end piece or the second end piece. In this embodiment, bar 170 may attach to closure devices 138 on either the first end piece or the second end piece. Two bars 170 may be used; in this case one bar 170 may be attached to closure devices 138 on first end piece 110 and another bar 170 may be attached to closure devices 138 on second end piece 120.

The shape of the cross-section of bar 170 may comprise a number of different shapes besides a round shape. The shape of bar 170 may be such that when an item is threaded over bar 170, the item will fit snugly against the surface of the bar and will not move without manual force. For example, the shape of the cross-section of bar 170 may be a diamond shape, a square or a rectangular shape. Alternatively, the size and shape of the cross-section of the bar 170 may vary along the length of the bar. The bar 170 may comprise a coil shape.

The bar may be made from a variety of materials. As an example, the bar may be made from plastic, wood, or a metal. The bar 170 may comprise a range of thicknesses and the cross-section may comprise a number of different diameters.

Closure device 138 may be a hinged snap back. The closure device may be a post and stud arrangement. The closure device may be a push-back clip. The closure device may be a snap post. The closure device may be an omega back. The closure device may be Velcro. The closure device may be a button tow, button snaps, snap bar, lever back, spring ring clasps or a hinged hook. Any of the aforementioned closure devices may be connected to the frames during the manufacture process.

Closure devices 138 may be manufactured as part of eyeglass frame 100. Alternatively, closure devices 138 may be separate from eyeglass frame 100. In this embodiment, each of closure devices 138 may have an adhesive on one surface of the closure device. A paper or other material may be pressed against the adhesive so that the adhesive is not activated until a user removes the material from the adhesive. Once the material is removed from the adhesive, a user may place closure devices 138 against a surface on eyeglass frames 100, and may press the adhesive against the surface. The adhesive will then bind the closure devices 138 to the surface of the eyeglass frame, affixing closure devices 138 to the frame. The adhesive may be a glue. However, the adhesive may be a number of other materials.

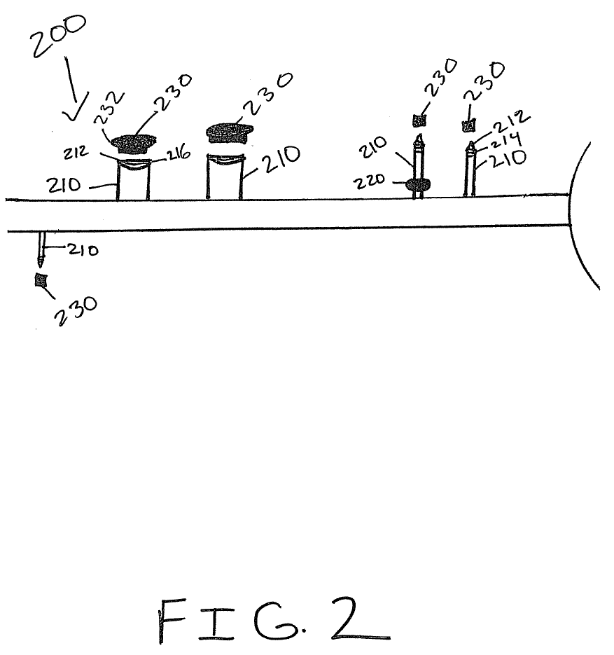

FIG. 2 shows an exemplary end piece 200 of eyeglass frame 100. End piece 200 may be first end piece 110 from FIG. 1a. Alternatively, the end piece may be second end piece 120 from FIG. 1 a. End piece 200 may comprise at least one post 210, wherein each post 210 extends from end piece 120 as shown in FIG. 2. Post 210 may extend at a non-zero angle from any point along the exterior surface of end piece 200. Post 210 comprises an open end 212.

Items 220 are made to be manually threaded over post 210, and may slide up or down the length of post 210. Each item 220 may have a hole (not shown) that extends through the entirety of the item so that item 220 may slide up or down post 210. The hole may be sized so that the fit of the item 220 on post 210 is a loose fit. Alternatively, the hole may be sized so that the fit of the item 220 on post 210 is a snug fit. After the desired items 220 are placed on post 210, a stopper 230 may cover open end 212 so that items 220 cannot slide off of post 210.

Posts 210 are not limited to being located on an end piece; posts 210 may also be present on various parts of the eyeglass frame. As an example, posts 210 may be located on first or second rims 134, 136. A large number of posts 210 may be present on the eyeglass frames. As an example, up to one hundred posts may be present on eyeglass frames 100. Posts 210 may be present on any style or shape of eyeglass frames. Posts 210 may comprise a wide range of lengths and widths.

A stopper 230 may be placed over open end 212 to prevent items 220 from falling off of post 210. Stopper 230 may be a manual screw-on stopper. Open end 212 may include a threaded portion 214. Stopper 230 may also comprise an interior hollow section with threads along the surface of the interior section, so that the threaded portion of stopper 230 may be mated with threaded portion 214 when stopper 230 is placed on top of open end 212. The stopper may then be manually turned and screwed down to post 210. When stopper 230 is screwed down the threaded portion 214, stopper 230 is affixed on open end 212.

As an alternative, as shown in FIG. 2, post 210 may not comprise a threaded portion, and stopper 230 may be a snap-on stopper. In this case, stopper 230 may comprise a lip 232 that is placed over open end 212. The lip may be manually pressed down over a rim 216 of open end 212, the lip 216 fitting around the edge of the rim and affixing stopper 230 to open end 212.

As another alternative, post 210 may not include a threaded portion, and stopper 230 may be a slide-on stopper, and may comprise a hollow interior that slides over open end 212 to provide a snug, friction fit so that stopper 230 is affixed over open end 212. Stopper 230 may be manufactured a variety of materials, for example, stopper 230 may be manufactured from wood, metal, or plastic.

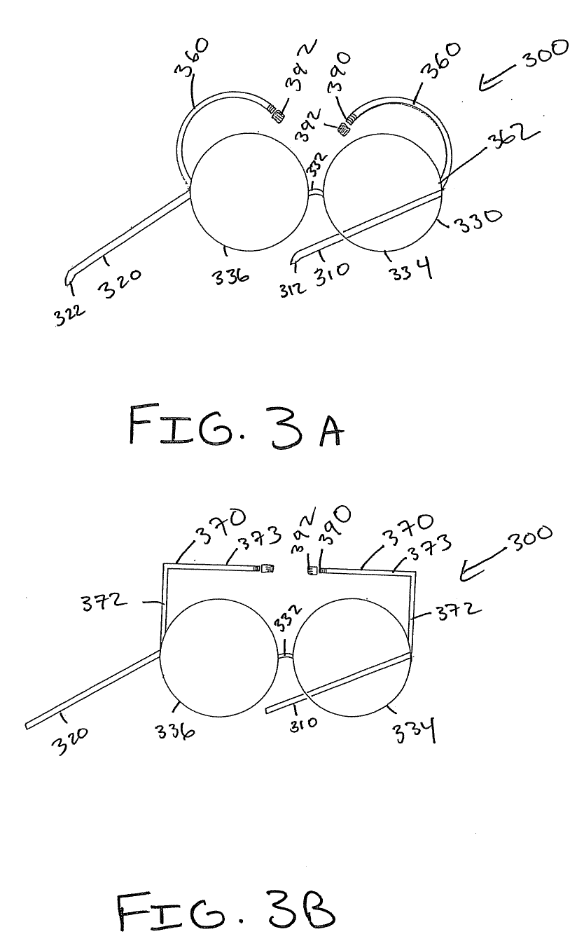

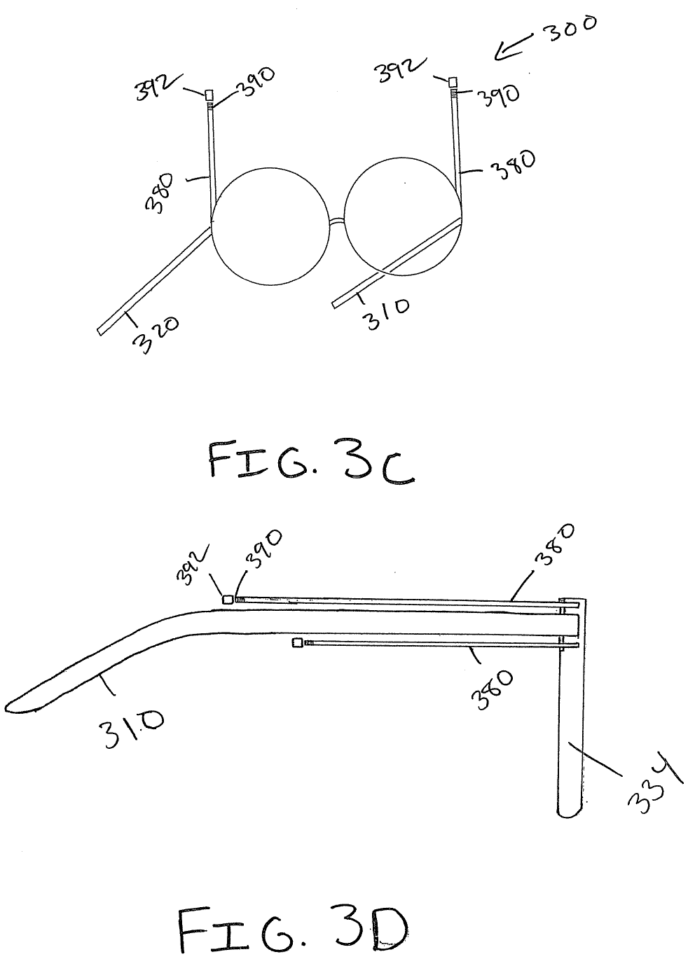

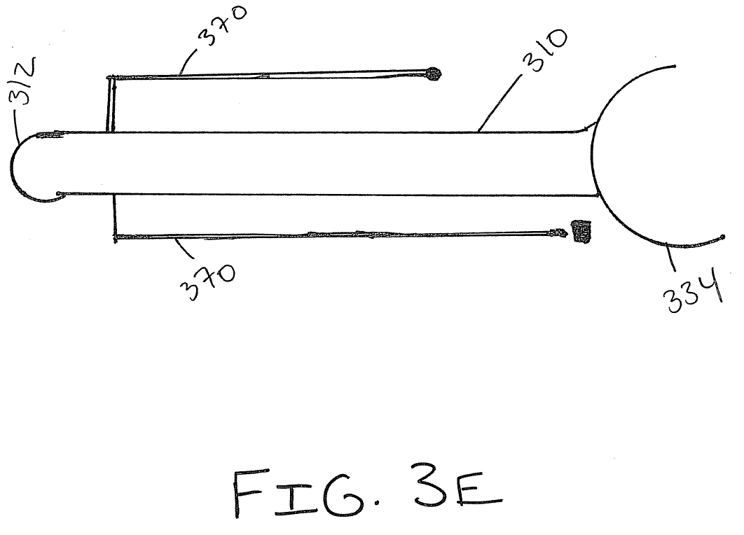

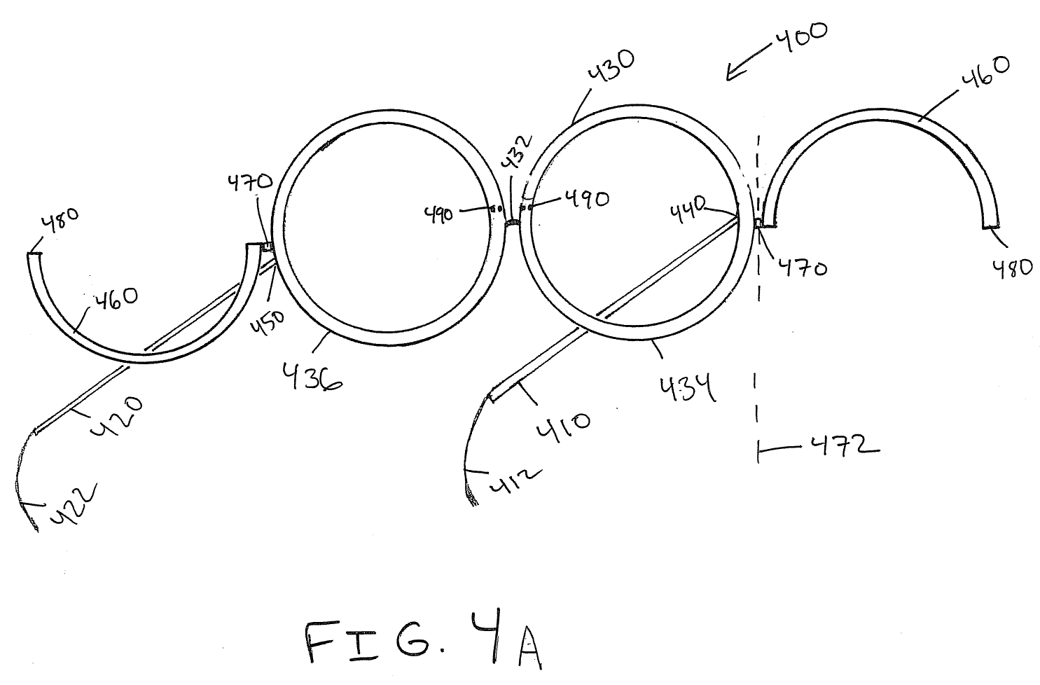

FIG. 3a illustrates an exemplary eyeglass frame 300 according to an embodiment of the present invention. Eyeglass frame 300 comprises a first end piece 310, a second end piece 320, a frame front 330, a first hinge 340, and a second hinge 350. Frame front 330 further comprises a bridge 332, a first rim 334, and a second rim 336. First end piece 310 comprises a first temple 312. Second end piece 320 comprises a second temple 322. First end piece 310 is connected to first rim 334 of frame front 330 with first hinge 340. Second end piece 320 is connected to second rim 336 of frame front 330.

At least one arced bar 360 may be attached to either first rim 334 or second rim 336. FIG. 3a shows two arced bars 360. Arced bar 360 may be in a fixed position above first or second rim 334, 336 as shown in FIG. 3a. Alternatively, arced bar 360 may sit behind first or second rim 334, 336 and may be manually slid up and locked into the position shown in FIG. 3a. A variety of locking mechanisms may be used to lock arced bar 360 into place in this alternative. As an example, a clip with two prongs may be placed on either the frame front or the end piece, and when arced bar is slid up into place, a portion of arced bar is pushed between the prongs of the clip, and the clip will lock the arced bar into place.

In an alternative shown in FIG. 3b, a bent bar 370 may be attached to either first rim 334 or second rim 336. Bent bar 370 may comprise a first rod 372 and a second rod 373, wherein first rod 372 is attached to either rim, the first rod extending at a 90 degree angle from an end piece 310 or end piece 320. Second rod 373 may be at a 90 degree angle from first rod 372, and may extend from first rod 372 toward bridge 332, as shown in FIG. 3b. Second rod 373 may be integral with first rod 372.

In another alternative, FIGS. 3c and 3d illustrate a straight bar 380 that may be attached to either first rim 334 or second rim 336. Straight bar 380 may extend at a 90 degree angle from end piece 310, as shown in FIG. 3c. Alternatively, as shown in FIG. 3d, straight bar 380 may extend parallel to end piece 310. More than one straight bar 380 may be present, as shown in FIG. 3d. In another alternative, bent bar 370 may be located on end piece 310 or end piece 320, as shown in FIG. 3e.

Arced bar 360, bent bar 370, and straight bar 380 may comprise an open end 390. A stopper 392 may be placed over open end 390 of each of arced bar 360, bent bar 370, and straight bar 380. Open end 390 may include a threaded portion, and stopper 392 may be a manual screw-on stopper.

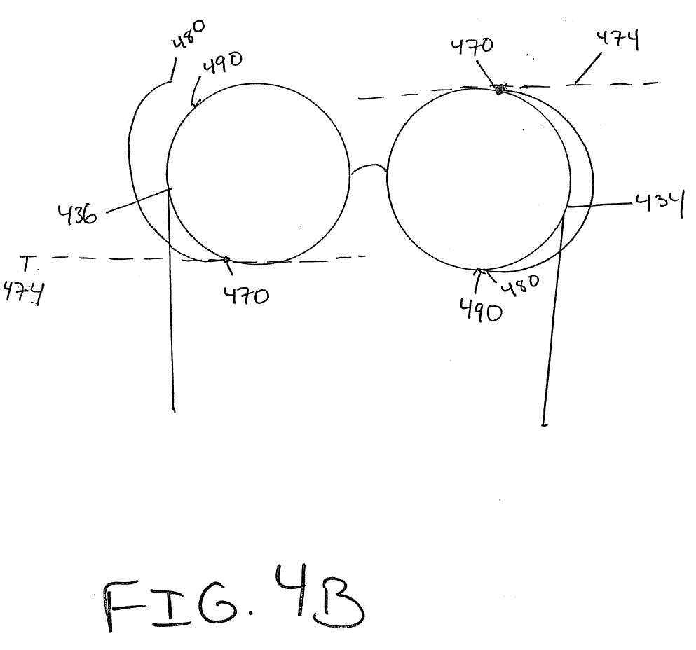

FIG. 4a illustrates an exemplary eyeglass frame 400 according to the present invention. Eyeglass frame 400 comprises a first end piece 410, a second end piece 420, a frame front 430, a first hinge 440, and a second hinge 450. Frame front 430 further comprises a bridge 432, a first rim 434, and a second rim 436. First end 410 comprises a first temple 412. Second end 420 comprises a second temple 422. First end piece 410 is connected to first rim 434 of frame front 430 with first hinge 440. Second end piece 420 is connected to second rim 436 of frame front 430 with second hinge 450. At least one rotatable bar 460 may be attached to either first rim 434 or second rim 436 with a bar hinge 470. Rotatable bar 460 may comprise a number of different widths. Rotatable bar 460 may also comprise a number of different shaped cross-sections. As an example, the cross-section of rotatable bar 460 may be square, rectangular, or diamond. The shape of rotatable bar 460 may be such that when rotatable bar 460 is placed on top of the rim, the shape of rotatable bar 460 lines up with and matches the perimeter of the rim. Each rotatable bar 460 further comprises an open end 480. In FIG. 4a, rotatable bar 460 moves on hinge 470 from an open position, as shown in the Figure, about a vertical axis 472 to a closed position in front of first or second rim 434, 436. A clip 490 may be located on first or second rims 434, 436 to affix rotatable bar 460 in place over the rims. In an alternate embodiment, FIG. 4b shows that each rotatable bar 460 may rotate on hinge 470 about horizontal axis 474. Open end 480 may be removably affixed to either first rim or second rim with a clip 490. Hinge 470 may be located at a number of locations along first rim 434 or second rim 436. In an alternate embodiment, rotatable bar 460 may be attached to either first rim 434 or second rim 436 with a ball joint, to allow for a larger degree of rotation of the bar.

Although FIGS. 4a and 4b show round rims 334, 336 and arced rotatable bars 460, other rim shapes and rotatable bar shapes may be contemplated.

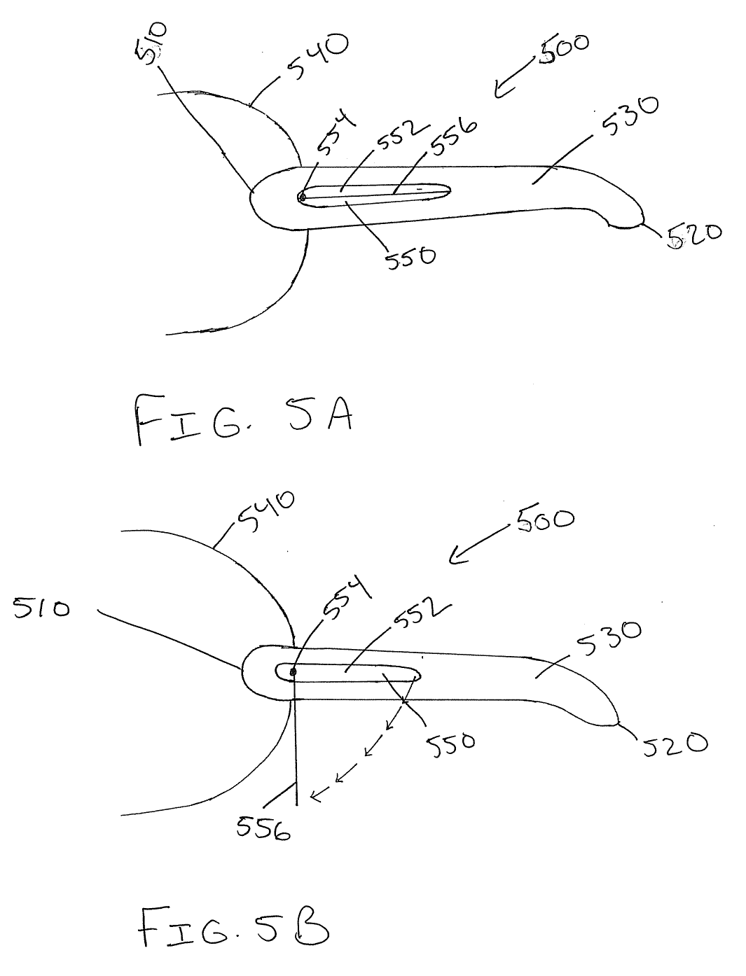

FIGS. 5a and 5b show an exemplary end piece 500 according to one embodiment of the present invention. End piece 500 comprises a first end 510, a second end 520, and an end piece surface 530. An eyeglass rim 540 is also shown in the Figure. In FIG. 5a, an adhesive bar assembly 550 has been placed on end piece 500. Adhesive bar assembly comprises a surface with an adhesive (not shown), an exterior surface 552, a hinge or ball joint 554, a bar 556, and a closure device 558. In the unlocked position, bar 556 rotates about hinge or ball joint 554, and a user may thread decorative items over bar 556. Once the desired items are placed on bar 556, bar 556 is manually rotated to the position in FIG. 5b, where a closure device 558 affixes the bar 556 in place. Closure device 558 may comprise a variety of different closure devices. As an example, closure device 558 may be a push-back clip. The closure device may be a snap post. The closure device may be an omega back. The closure device may be Velcro. The closure device may be a button tow, button snaps, snap bar, lever back, spring ring clasps or a hinged hook. Once bar 556 is secured to closure device 558, the decorative items will not fall off the bar.

Any of the features discussed for the eyeglass frames in FIGS. 1-5 may be used in combination or alone. It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. An eyeglass frame, comprising:
a first end piece, comprising a first end and a second end;
a second end piece, comprising a first end and a second end;
a frame front, wherein the frame front comprises a bridge, a first rim, and a second rim;
a first hinge, wherein the first hinge attaches the first end of the first end piece to the first rim of the frame front;
a second hinge, wherein the second hinge attaches the first end of the second end piece to the second rim of the frame front; and
a bar, wherein the bar is removably attachable to the frame front.

2. The eyeglass frame of claim 1, wherein the bar is attached to the frame front with at least one closure device.

3. The eyeglass frame of claim 1, wherein the first end piece comprises a plurality of closure devices, and the bar is removably attachable to the closure devices on the first end piece.

4. The eyeglass frame of claim 1, wherein the second end piece comprises a plurality of closure devices, and the bar is removably attachable to the closure devices on the second end piece.

5. The eyeglass frame of claim 1, the first end piece further comprising at least one post, wherein each post extends at a non-zero angle from the first end piece and comprises an open end.

6. The eyeglass frame of claim 1, the second end piece further comprising at least one post, wherein each post extends at a non-zero angle from the second end piece and comprises an open end.

7. The eyeglass frame of claim 5, wherein a stopper is affixed to the open end.

8. The eyeglass frame of claim 6, wherein a stopper is affixed to the open end.

9. The eyeglass frame of claim 1, wherein the second end of each of the first end piece and second end piece comprises a removably attachable end portion.

10. An eyeglass frame, comprising:
a first end piece, comprising a first end and a second end;
a second end piece, comprising a first end and a second end;
a frame front, wherein the frame front comprises a bridge, a first rim, and a second rim;
a first hinge, wherein the first hinge attaches the first end of the first end piece to the first rim of the frame front;
a second hinge, wherein the second hinge attaches the first end of the second end piece to the second rim of the frame front; and
at least one bar, wherein the bar comprises a first end and a second end, and wherein the first end is affixed to either the first rim or the second rim and wherein the second end is a free end, the free end further comprising a removable stopper.

11. The eyeglass frame of claim 10, wherein the at least one bar has the shape of an arc.

12. The eyeglass frame of claim 10, wherein the at least one bar is a straight bar.

13. The eyeglass frame of claim 10, wherein the at least one bar comprises a first rod and a second rod, wherein the second rod is affixed to the first rod at a 90 degree angle.

14. The eyeglass frame of claim 13, wherein the first rod is integral with the second rod.

15. The eyeglass frame of claim 11, wherein the first end is affixed to the first rim with a third hinge, and arced bar is rotatable on the third hinge about a vertical axis.

16. The eyeglass frame of claim 11, wherein the first end is affixed to the first rim with a third hinge, and arced bar is rotatable on the third hinge about a horizontal axis.

17. The eyeglass frame of claim 15, wherein the free end of the arced bar is removably attachable to the frame front.

18. The pod of claim 16, wherein the free end of the arced bar is removably attachable to the frame front.

19. The eyeglass frame of claim 15, wherein the free end is attachable with a closure device.

20. An eyeglass frame, comprising:
a first end piece, comprising a first end and a second end;
a second end piece, comprising a first end and a second end;
a frame front, wherein the frame front comprises a bridge, a first rim, and a second rim;
a first hinge, wherein the first hinge attaches the first end of the first end piece to the first rim of the frame front;
a second hinge, wherein the second hinge attaches the first end of the second end piece to the second rim of the frame front; and
at least one bar, wherein the bar comprises a first end and a second end, wherein the first end is affixed to either the first rim or the second rim and wherein the second end is a free end, and wherein the first end of the bar is affixed to the first rim with a ball joint.
